(19) United States
(12) Patent Application Publication
(10) Pub. No.: US 2024/0329776 A1
(43) Pub. Date: Oct. 3, 2024

(54) INPUT DEVICE

(71) Applicant: LAPIS Technology Co., Ltd., Yokohama (JP)

(72) Inventor: Keisuke KIYOMIZU, Yokohama-shi (JP)

(73) Assignee: LAPIS Technology Co., Ltd., Yokohama (JP)

(21) Appl. No.: 18/619,960

(22) Filed: Mar. 28, 2024

(30) Foreign Application Priority Data
Mar. 30, 2023 (JP) 2023-054805

(51) Int. Cl. G06F 3/041; G06F 3/044

(52) U.S. Cl. CPC G06F 3/041662; G06F 3/0446; G06F 3/0418; G06F 2203/04104

(57) ABSTRACT

An input device includes a capacitive sensor matrix, a drive unit, and a mode signal transmitting unit. The capacitive sensor matrix is configured to accommodate a self-capacitive mode and a mutual-capacitive mode. The drive unit drives the sensor matrix in any one mode of the self-capacitive mode and the mutual-capacitive mode. The mode signal transmitting unit includes a touch detection circuit that senses that a touch has been performed on the sensor matrix in a predetermined manner while the drive unit drives the sensor matrix in the self-capacitive mode. The mode signal transmitting unit transmits a first switching signal to the drive unit when the touch detection circuit senses that the predetermined touch has been performed on the sensor matrix. The first switching signal indicates switching of the mode from the self-capacitive mode to the mutual-capacitive mode.

### CROSS-REFERENCE TO RELATED APPLICATION

This application is based upon and claims the benefit of priority from the prior Japanese Patent Application No. 2023-054805 filed on Mar. 30, 2023, the entire contents of which are incorporated herein by reference.

### BACKGROUND

### 1. Technical Field

The disclosure relates to an input device.

### 2. Description of the Related Art

Currently, capacitive touch panels are mainstream in the touch sensing method of touch panels as input devices employed in smartphones and the like. The capacitive method includes self-capacitive and mutual-capacitive touch sensing methods. For example, the self-capacitive method excels in power consumption but cannot cope with problems, such as multi-touch and adhesion of conductive foreign matter to a touch panel, whereas the mutual-capacitive method can cope with the above-described problems but has a larger power consumption than the self-capacitive method. Thus, each method has advantageous and disadvantageous characteristics.

Recently, hybrid touch panels of the self-capacitive and mutual-capacitive methods are becoming widespread, and a technique to switch between the self-capacitive method and the mutual-capacitive method according to a user operation has been developed.

For example, JP-A-2017-10375 discloses a technique in which in order to determine a capacitive switch at which a user operation (touch) has been performed (a position in an input device) among a plurality of capacitive switches, a processing unit switches between a self-capacitive method and a mutual-capacitive method to detect respective self-capacitance and mutual capacitance values and determines that a capacitive switch at which a self-capacitance value or mutual capacitance value equal to or more than a predetermined threshold is detected as the capacitive switch at which the user operation has been performed.

However, in the input device disclosed in JP-A-2017-10375, in order to determine the capacitive switch at which a user operation has been performed, both the self-capacitive method and the mutual-capacitive method are performed for one user operation, and the self-capacitive method and the mutual-capacitive method are not switched according to the user operation. Therefore, an increase in power consumption is expected for this input device.

In addition, the processing unit that switches between the self-capacitive method and the mutual-capacitive method in the input device is a processor, such as a CPU. In the processing unit, a load of, for example, determination program processing of the capacitive switch at which the user operation has been performed based on the detected self-capacitance value and the mutual capacitance value or program processing of other applications and the like may result in a delay in switching between the self-capacitive method and the mutual-capacitive method to cause false detection or slow response to the user operation.

The disclosure has been made in consideration of the above-described points and an object of the disclosure is to provide an input device that can improve switching speed between a self-capacitive method and a mutual-capacitive method while reducing power consumption.

### SUMMARY

An input device according to the disclosure includes a capacitive sensor matrix, a drive unit, and a mode signal transmitting unit. The capacitive sensor matrix is configured to accommodate a self-capacitive mode and a mutual-capacitive mode. The drive unit drives the sensor matrix in any one mode of the self-capacitive mode and the mutual-capacitive mode. The mode signal transmitting unit includes a touch detection circuit that senses that a touch has been performed on the sensor matrix in a predetermined manner while the drive unit drives the sensor matrix in the self-capacitive mode. The mode signal transmitting unit transmits a first switching signal to the drive unit when the touch detection circuit senses that the predetermined touch has been performed on the sensor matrix. The first switching signal indicates switching of the mode from the self-capacitive mode to the mutual-capacitive mode.

### BRIEF DESCRIPTION OF THE DRAWINGS

FIG. 1 is a diagram illustrating a configuration of a touch panel according to Embodiment 1;

FIG. 2 is a block diagram illustrating an operation during a self-capacitive method of the touch panel according to Embodiment 1;

FIG. 3 is a block diagram illustrating an operation during a mutual-capacitive method of the touch panel according to Embodiment 1; and

FIG. 4 is a diagram illustrating a configuration of a touch panel according to Embodiment 2.

### DETAILED DESCRIPTION

Embodiments of the disclosure will be described in detail with reference to the drawings below.

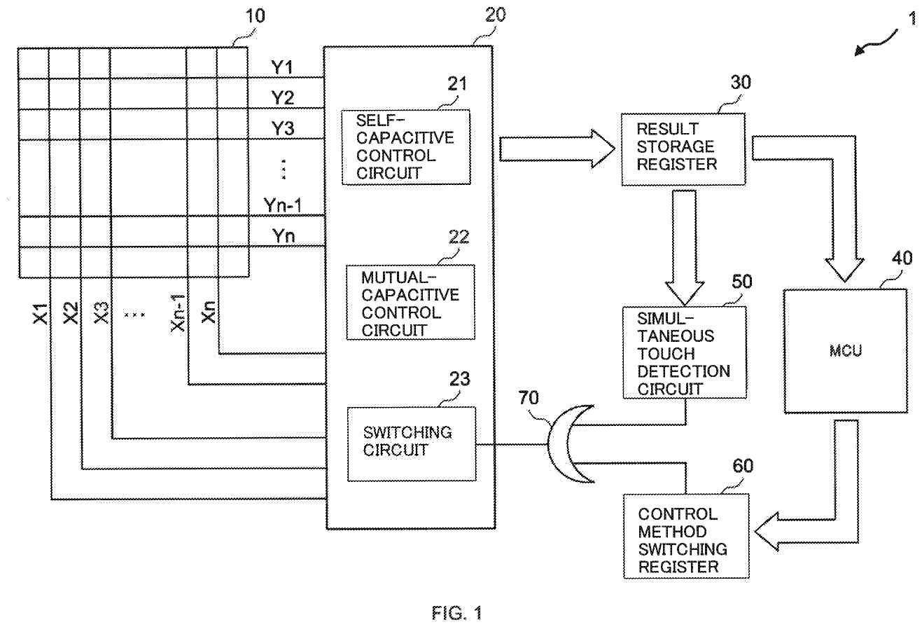

FIG. 1 is a diagram illustrating a configuration of an input device 1 according to Embodiment 1.

The input device 1 is an input device that, for example, is mounted so as to overlap a display panel (not illustrated) of an electronic device, such as a smartphone, and senses that input has been performed by touching a position (coordinate) corresponding to an image displayed on the display panel with a user's finger and the like. In addition, the input device 1 is an input device that senses the input using a capacitive method. That is, the input device 1 is a touch sensor portion of a capacitive touch panel display.

A sensor matrix 10 has Y-line electrodes Y1, Y2, Y3, . . . . Yn−1, and Yn and X-line electrodes X1, X2, X3, . . . , Xn−1, and Xn formed in a grid pattern. The Y-line electrodes Y1, Y2, Y3, . . . , Yn−1, and Yn and the X-line electrodes X1, X2, X3, . . . , Xn−1, and Xn are formed separately from one another. This causes the Y-line electrodes Y1, Y2, Y3, . . . , Yn−1, and Yn and the X-line electrodes X1, X2, X3, . . . , Xn−1, and Xn to form sensor coordinates of coordinates (Y1, X1) to (Yn, Xn) on the sensor matrix 10 by the Y-line and X-line electrodes adjacent to one another.

A drive unit 20 is connected to the Y-line electrodes Y1, Y2, Y3, . . . , Yn−1, and Yn and the X-line electrodes X1, X2, X3, . . . , Xn−1, and Xn and drives the sensor matrix 10.

The drive unit 20 includes a self-capacitive control circuit 21 that drives the sensor matrix 10 in a self-capacitive mode, a mutual-capacitive control circuit 22 that drives the sensor matrix 10 in a mutual-capacitive mode, and a switching circuit 23 that switches between the self-capacitive control circuit 21 and the mutual-capacitive control circuit 22 so that the sensor matrix 10 is driven in any one drive mode of the self-capacitive mode or the mutual-capacitive mode.

The self-capacitive control circuit 21 and the mutual-capacitive control circuit 22 drive the Y-line electrodes Y1, Y2, Y3, . . . , Yn−1, and Yn and the X-line electrodes X1, X2, X3, . . . , Xn−1, and Xn and measure a change in capacitance value during the self-capacitive mode and the mutual-capacitive mode of the sensor matrix 10. In addition, the self-capacitive control circuit 21 and the mutual-capacitive control circuit 22 perform analog-digital conversion of the change in the capacitance value measured and output it to a result storage register 30.

The switching circuit 23 switches to drive any one of the self-capacitive control circuit 21 and the mutual-capacitive control circuit 22 based on a switching signal described later. Specifically, the switching circuit 23 causes the self-capacitive control circuit 21 to drive the sensor matrix 10 when a logic level of the supplied switching signal is 0 and causes the mutual-capacitive control circuit 22 to drive the sensor matrix 10 when the logic level of the switching signal is 1.

That is, in the input device 1 of Embodiment 1, the sensor matrix 10 is driven by the self-capacitive control circuit 21 in a normal operation (the logic level of the switching signal is 0), and the switching circuit 23 switches from the self-capacitive control circuit 21 to the mutual-capacitive control circuit 22 under a predetermined condition described later (the logic level of the switching signal is 1).

Thus, the input device 1 of Embodiment 1 can reduce power consumption by switching from the self-capacitive mode to the mutual-capacitive mode only when the sensor matrix 10 needs to be in the mutual-capacitive mode.

The result storage register 30 is a register that stores input results of the respective coordinates (Y1, X1) to (Yn, Xn) of the sensor matrix 10 output from the drive unit 20.

For example, the result storage register 30 holds and outputs an input result per scan of the self-capacitive control circuit 21 or the mutual-capacitive control circuit 22 of the drive unit 20.

An MCU 40 is, for example, a processor that integrally controls an electronic device to which the input device 1 is mounted. For example, the MCU 40 identifies the coordinates of the sensor matrix 10 at which a user has performed input from the input results of the respective Y-line and X-line electrodes supplied from the result storage register 30. In addition, the MCU 40 executes a program of an interlocking application based on an image displayed on a display panel (not illustrated) of the electronic device and the coordinates of the sensor matrix 10 at which the user has performed input. Moreover, the MCU 40 controls switching of the capacitive mode of the sensor matrix 10 of the input device 1 based on an instruction of the application or the input results at the respective coordinates of the sensor matrix 10 supplied from the result storage register 30.

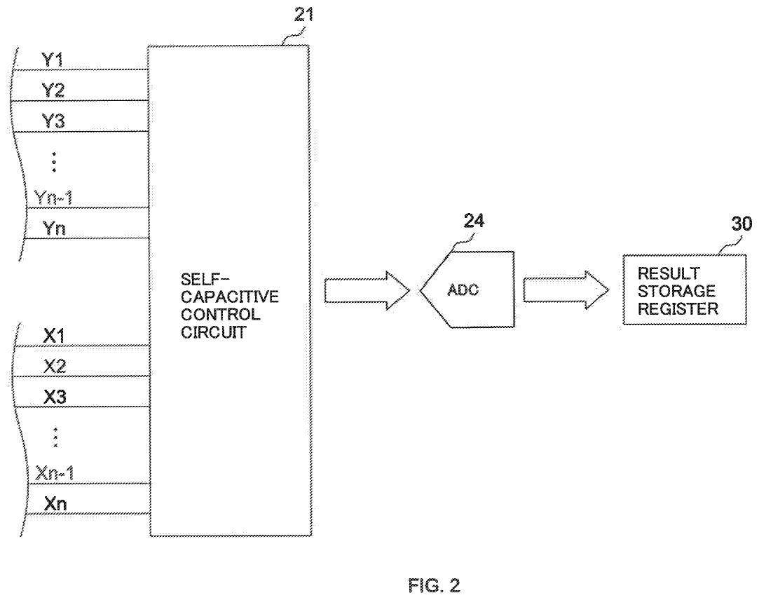

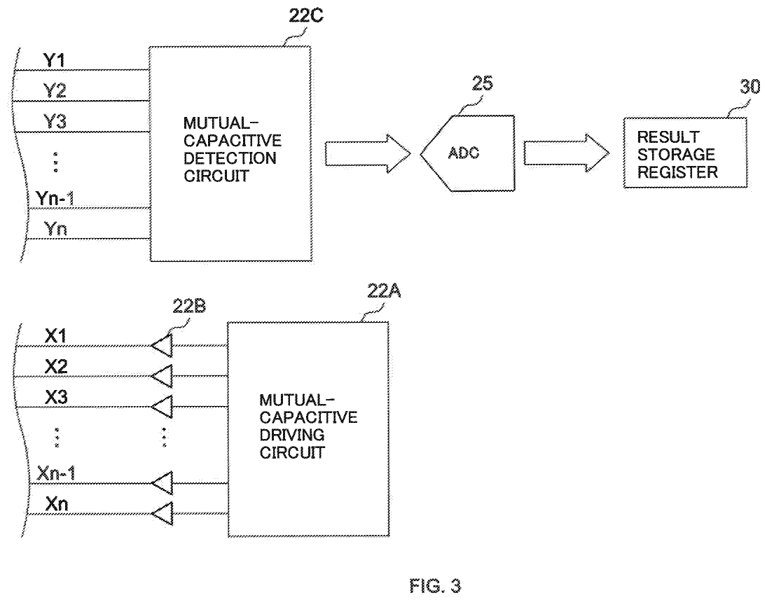

Here, using FIG. 2 and FIG. 3, the self-capacitive mode and the mutual-capacitive mode in a capacitive touch panel and operations of the drive unit 20 when it is driving in the respective modes will be described.

FIG. 2 is a block diagram of a case where, in the input device 1, the switching circuit 23 selects the self-capacitive control circuit 21 and causes the self-capacitive control circuit 21 to drive the sensor matrix 10 in the self-capacitive mode.

The self-capacitive control circuit 21 applies a voltage to each of the Y-line electrodes Y1, Y2, Y3, . . . , Yn−1, and Yn and the X-line electrodes X1, X2, X3, . . . , Xn−1, and Xn to generate an electric field immediately above each electrode.

In addition, the self-capacitive control circuit 21 sequentially measures the change in the capacitance value of each line electrode, for example, in the order of the Y-line electrodes and the X-line electrodes.

For example, the self-capacitive control circuit 21 sequentially measures the change in the capacitance value of each Y-line electrode of the Y-line electrodes Y1 to Yn as a first scan. Next, as a second scan, the change in the capacitance value of each X-line electrode of the X-line electrodes X1 to Xn is sequentially measured. The self-capacitive control circuit 21 of the drive unit 20 repeats the scans and continues to measure the changes in the capacitance values at the respective coordinate of the sensor matrix 10.

For example, when a user performs input (a touch) on the sensor matrix 10 with a finger, a pseudo-capacitor is formed between the Y-line and X-line electrodes and the user's finger at the input point. This increases the capacitance values of the Y-line and X-line electrodes at the input point.

In addition, the self-capacitive control circuit 21 sequentially outputs the changes in the capacitance values of the Y-line and X-line electrodes measured to an analog-digital converter 24.

For example, the analog-digital converter 24 converts the Y-line and X-line electrode numbers at which the capacitance value has increased to a signal having a logic level 1, converts the Y-line and X-line electrode numbers at which the capacitance value has not changed to a signal having a logic level 0, and outputs these to the result storage register 30 as the input results.

The result storage register 30 holds and outputs the input result per scan of the self-capacitive control circuit 21.

The MCU 40 determines the coordinates of the sensor matrix 10 at which the user has performed input from the Y-line and X-line electrodes having the logic level 1 based on the input results output from the result storage register 30. FIG. 3 is a block diagram of a case where, in the input device 1, the switching circuit 23 selects the mutual-capacitive control circuit 22 and causes the mutual-capacitive control circuit 22 to drive the sensor matrix 10 in the mutual-capacitive mode.

The mutual-capacitive control circuit 22 includes a mutual-capacitive driving circuit 22A and driving drivers 22B on the X-line electrodes X1, X2, X3, . . . , Xn−1, and Xn. The mutual-capacitive driving circuit 22A performs drive control for the X-line electrodes. The driving drivers 22B apply pulse voltages to the respective X-line electrodes according to the mutual-capacitive driving circuit 22A. In addition, the mutual-capacitive control circuit 22 includes a mutual-capacitive detection circuit 22C that measures the capacitance values between the X-line electrodes X1, X2, X3, . . . , Xn−1, and Xn and each Y-line electrode adjacent to one another in each of the Y-line electrodes Y1, Y2, Y3, . . . , Yn−1, and Yn.

For example, the mutual-capacitive driving circuit 22A sequentially applies a pulse voltage to the X-line electrodes X1, X2, X3, . . . , Xn−1, and Xn via the driving drivers 22B to generate an electric field between an X-line electrode to which the pulse voltage is applied and the Y-line electrodes adjacent thereto.

For example, the mutual-capacitive detection circuit 22C sequentially measures the change in the capacitance value between a Y-line electrode and the X-line electrode to which the pulse voltage is applied.

For example, the mutual-capacitive detection circuit 22C sequentially measures a mutual capacitance value with respect to the X-line electrode X1, the mutual capacitance value with respect to the X-line electrode X2, . . . , the mutual capacitance value with respect to the X-line electrode Xn in the Y-line electrode Y1 as a first scan. Next, the mutual-capacitive detection circuit 22C sequentially measures the mutual capacitance values with respect to the X-line electrodes X1 to Xn in the Y-line electrode Y2 as a second scan in a similar manner. The mutual-capacitive detection circuit 22C repeats this scan up to the Y-line electrode Yn as an n-th scan to measure the capacitance values at the respective coordinates of the sensor matrix 10. The mutual-capacitive detection circuit 22C further repeats this and continues to measure the capacitance values at the respective coordinates of the sensor matrix 10.

For example, when a user performs input (a touch) on the sensor matrix 10 with a finger, a pseudo-capacitor is formed between an X-line electrode to which the pulse voltage is input and the user's finger at the input point. This decreases the capacitance value between the X-line electrode to which the pulse voltage is applied and a Y-line electrode adjacent thereto at the input point.

In addition, the mutual-capacitive detection circuit 22C sequentially outputs the changes in the capacitance values measured between the X-line electrode to which the pulse voltage is applied and the Y-line electrodes adjacent thereto to an analog-digital converter 25.

For example, the analog-digital converter 25, converts the Y-line and X-line electrode numbers (coordinate of the sensor matrix 10) at which the capacitance value has decreased to a signal having the logic level 1, converts the Y-line and X-line electrode numbers at which the capacitance value has not changed to a signal having the logic level 0, and outputs these to the result storage register 30 as the input results.

The result storage register 30 holds and outputs the input result per scan of the mutual-capacitive detection circuit 22C.

The MCU 40 determines the coordinates of the sensor matrix 10 at which the user has performed input from the Y-line and X-line electrodes having the logic level 1 based on the input results output from the result storage register 30.

Returning to FIG. 1, a switching operation from the self-capacitive mode to the mutual-capacitive mode of the sensor matrix 10 in the input device 1 of Embodiment 1 will be described.

A simultaneous touch detection circuit 50 is a circuit that senses that input has been performed at a plurality of coordinates of the sensor matrix 10 simultaneously (multi-touch) while the sensor matrix 10 is driven by the self-capacitive control circuit 21. Specifically, based on the input result supplied per scan from the result storage register 30, the simultaneous touch detection circuit 50 senses that input has been performed at a plurality of coordinates of the sensor matrix 10 simultaneously is sensed.

As described above, the sensor matrix 10 is driven in the self-capacitive mode by the self-capacitive control circuit 21 in the normal operation. At this time, when a user performs a multi-touch on the sensor matrix 10, information on a digital input result that the logic levels of a plurality of coordinates including ghost points become 1 is supplied from the result storage register 30.

The simultaneous touch detection circuit 50 outputs a first switching signal of the logic level 1 indicating that the drive mode of the sensor matrix 10 is switched from the self-capacitive mode to the mutual-capacitive mode in response to the supply of the information on the input result that the logic levels of the plurality of coordinates become 1.

The simultaneous touch detection circuit 50 can be achieved, for example, by a simple adder circuit or the like. For example, the simultaneous touch detection circuit 50 adds the input results of the Y-line electrodes Y1 to Yn when the input results of the Y-line electrodes Y1 to Yn as the above-described first scan in the self-capacitive mode is supplied from the result storage register 30. At this time, when an addition result of the input results of the Y-line electrodes Y1 to Yn is 2 or more, the first switching signal is output. That is, as long as at least two or more lines among the Y-line electrodes Y1 to Yn are touched (input) by the user, the adder circuit, which is the simultaneous touch detection circuit 50, can sense that input has been performed at the plurality of coordinates of the sensor matrix 10 simultaneously.

A control method switching register 60 outputs a second switching signal of the logic level 1 indicating that the drive mode of the sensor matrix 10 is switched from the self-capacitive mode to the mutual-capacitive mode based on a switching instruction information supplied from the MCU 40.

When it is necessary to switch the sensor matrix 10 from the self-capacitive mode to the mutual-capacitive mode under different circumstances from the application instruction or the multi-touch by the user, the MCU 40 rewrites the control method switching register 60 to change the second switching signal from the logic level 0 to the logic level 1.

An OR circuit 70 supplies the switching circuit 23 of the drive unit 20 with a logical disjunction of the first switching signal output from the simultaneous touch detection circuit 50 and the second switching signal output from the control method switching register 60. That is, the switching circuit 23 of the drive unit 20 performs switching from the self-capacitive control circuit 21 to the mutual-capacitive control circuit 22 when the logic level of any one of the first switching signal or the second switching signal becomes 1. The simultaneous touch detection circuit 50 and the OR circuit 70 can constitute a mode signal transmitting unit of the disclosure.

As described above, in the input device 1 of Embodiment 1, a multi-touch by a user is detected by hardware of the simultaneous touch detection circuit 50, such as an adder circuit, without program processing by software of the MCU 40. This can reduce a switching delay of the drive mode of the sensor matrix 10 due to a load of program processing and the like of the MCU 40 and improve switching speed from the self-capacitive mode to the mutual-capacitive mode. In addition, this allows the input device 1 of Embodiment 1 to reduce false detection and a response delay to a user operation.

Moreover, in the MCU 40, multi-touch detection program processing and switching program processing from the self-capacitive mode to the mutual-capacitive mode based on the multi-touch detection program processing can be excluded, enabling a reduction in the load of the MCU 40 and a reduction in power consumption.

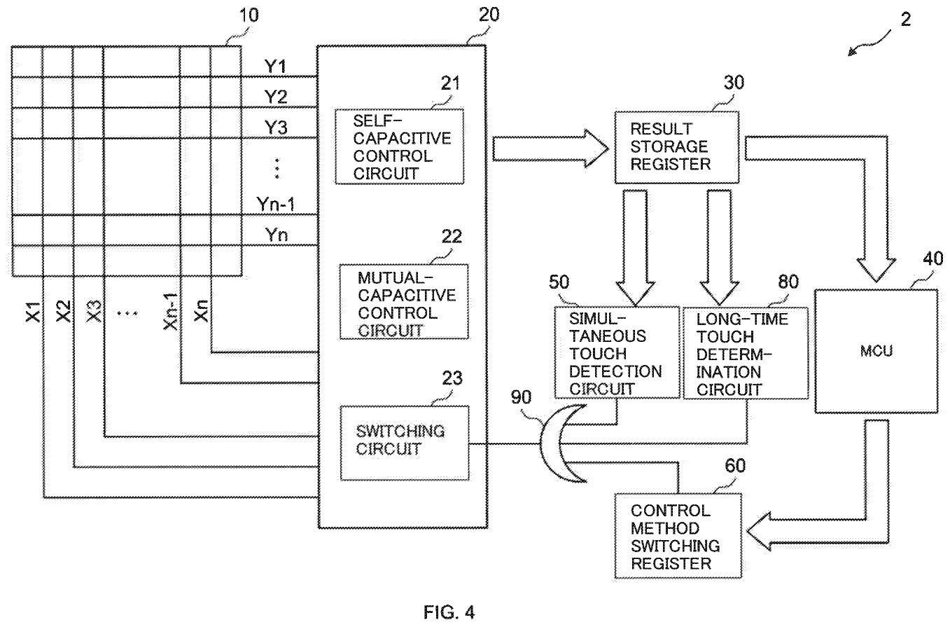

FIG. 4 is a diagram illustrating a configuration of an input device 2 according to Embodiment 2.

The input device 2 of Embodiment 2 basically has a configuration similar to that of the input device 1 of Embodiment 1. The input device 2 of Embodiment 2 differs in that it has a long-time touch determination circuit 80. In addition, the input device 2 of Embodiment 2 differs in that an OR circuit 90 outputs a logical disjunction of respective outputs of the simultaneous touch detection circuit 50, the control method switching register 60, and the long-time touch determination circuit 80.

For example, the long-time touch determination circuit 80 determines whether or not conductive foreign matter, such as water droplets, adheres to the sensor matrix 10 based on the information of the input results of the sensor matrix 10 supplied from the result storage register 30.

In the self-capacitive mode, when conductive foreign matter adheres to the sensor matrix 10, it is difficult to discriminate it from input by a user. Therefore, in the self-capacitive mode, erroneous input that the user does not intend may be detected at the coordinates to which the conductive foreign matter adheres.

The long-time touch determination circuit 80 outputs a third switching signal indicating switching from the self-capacitive mode to the mutual-capacitive mode when it determines that input has been performed for a predetermined period of time at predetermined coordinates of the sensor matrix 10.

Specifically, it is assumed that an erroneous input time due to the adhesion of conductive foreign matter is longer than an input time by a user operation. Therefore, the long-time touch determination circuit 80 determines that conductive foreign matter adheres to respective coordinates of the sensor matrix 10 when, for example, input has continued for one second or more at the coordinates and outputs the third switching signal of the logic level 1.

The long-time touch determination circuit 80 can be achieved, for example, by a simple counter circuit or the like. For example, when the input results of the sensor matrix 10 are supplied from the result storage register 30 during the self-capacitive mode, the long-time touch determination circuit 80 counts the input results of the same Y-line electrode or X-line electrode number having the logic level 1 during a plurality of scan times at the counter circuit. The long-time touch determination circuit 80 outputs the third switching signal when the count number of the counter circuit is equal to or more than a predetermined number of times.

That is, as long as the input has continued for a predetermined period of time at an electrode having the same number in at least one line electrodes of the Y-line electrodes or the X-line electrodes, the counter circuit, which is the long-time touch determination circuit 80, can sense that conductive foreign matter adheres to the sensor matrix 10. The simultaneous touch detection circuit 50, the long-time touch determination circuit 80, and the OR circuit 90 can constitute a mode signal transmitting unit of the disclosure.

As described above, in addition to the effect of the input device 1 of Embodiment 1, the input device 2 of Embodiment 2 can reduce false detection due to conductive foreign matter adhering to the sensor matrix 10 and a response delay to input by a user during the conductive foreign matter adhesion.

Moreover, in the MCU 40, determination program processing of the conductive foreign matter adhesion to the sensor matrix 10 and switching program processing from the self-capacitive mode to the mutual-capacitive mode based on the determination program processing of the conductive foreign matter adhesion can be excluded, enabling a reduction in the load of the MCU 40 and a reduction in power consumption.

What is claimed is:

1. An input device comprising:
a capacitive sensor matrix configured to accommodate a self-capacitive mode and a mutual-capacitive mode;
a drive unit that drives the sensor matrix in any one mode of the self-capacitive mode and the mutual-capacitive mode; and
a mode signal transmitting unit including a touch detection circuit that senses that a touch has been performed on the sensor matrix in a predetermined manner while the drive unit drives the sensor matrix in the self-capacitive mode, wherein
the mode signal transmitting unit transmits a first switching signal to the drive unit when the touch detection circuit senses that the predetermined touch has been performed on the sensor matrix, the first switching signal indicating switching of the mode from the self-capacitive mode to the mutual-capacitive mode.

2. The input device according to claim 1, further comprising:
a control MCU configured to transmit a second switching signal for switching the mode from the self-capacitive mode to the mutual-capacitive mode, wherein
the mode signal transmitting unit has an OR circuit that receives the first switching signal and the second switching signal as inputs, and
the OR circuit has an output connected to the drive unit.

3. The input device according to claim 2, wherein
the touch detection circuit includes a simultaneous touch detection circuit that outputs the first switching signal when sensing that a plurality of touches have been performed on the sensor matrix simultaneously while the drive unit drives the sensor matrix in the self-capacitive mode.

4. The input device according to claim 2, wherein
the touch detection circuit has a long-time touch determination circuit that outputs a third switching signal when a same single point has been continuously touched for a predetermined period of time while the sensor matrix is in the self-capacitive mode.

5. The input device according to claim 4, wherein
the OR circuit receives the first switching signal, the second switching signal, and the third switching signal as inputs.
